(19) United States
(12) Patent Application Publication
(10) Pub. No.: US 2026/0099535 A1
(43) Pub. Date: Apr. 9, 2026

(54) Systems and Methods for Generating Recommendations from Unstructured Data Using Machine Learning Models

(71) Applicant: Join, Inc., Oakland, CA (US)

(72) Inventors: Nicholas Zukoski, Brooklyn, NY (US); Andrew Zukoski, Berkeley, CA (US); Kevin Rakestraw, Portland, OR (US); Mark Deutsch, Durham, NC (US); Ariel Zilnik, Toronto (CA); Shea Kusiak, Los Angeles, CA (US)

(73) Assignee: Join, Inc., Oakland, CA (US)

(21) Appl. No.: 19/353,472

(22) Filed: Oct. 8, 2025

Related U.S. Application Data
(60) Provisional application No. 63/705,002, filed on Oct. 8, 2024.

(51) Int. Cl. G06F 16/38; G06F 16/335; G06F 16/35

(52) U.S. Cl. CPC G06F 16/38; G06F 16/335; G06F 16/35

(57) ABSTRACT

Systems and methods for generating item recommendations from unstructured data using machine learning models are disclosed. One embodiment includes obtaining a dataset comprising a plurality of items, wherein each item includes at least one field containing unstructured data, preprocessing the dataset by performing filtering and text cleanup on the unstructured data, performing a coarse relatedness analysis by executing lookups on items in the dataset to identify potentially similar items and create links between items that are potentially interchangeable, performing coarse clustering by utilizing the links to organize related items into clusters using graph operations, performing fine clustering by constructing prompts for a large language model for each cluster to recluster items into subclusters and generate labels for canonical items and generating a list of interchangeable item recommendations based on the canonical items and their associated metadata.

### CROSS-REFERENCE TO RELATED APPLICATIONS

The current application claims the benefit of and priority under 35 U.S.C. § 119(e) to U.S. Provisional Patent Application No. 63/705,002, entitled “Systems and Methods for Generating Recommendations from Unstructured Data Using Machine Learning Models”, filed Oct. 8, 2024, the disclosure of which is incorporated herein by reference in its entirety for all purposes.

### FIELD OF THE INVENTION

The present invention relates generally to finding similarities between items in a dataset and more specifically to multi-stage relatedness using graph theory and machine learning.

### BACKGROUND

In many industries and applications, decision-makers face the challenge of selecting between numerous items or materials that may serve similar functions but possess different characteristics. This selection process often involves evaluating the interchangeability of items based on various factors such as performance, cost, availability, and suitability for specific applications. The complexity of these decisions increases when dealing with large sets of diverse items with varying degrees of similarity and substitutability.

Traditional approaches to identifying item similarities and generating recommendations typically rely on structured data with consistent categorization schemes and standardized attributes. However, many real-world datasets contain substantial amounts of unstructured data, including natural language descriptions, user-generated content, and inconsistent tagging systems. This unstructured nature presents challenges for conventional recommendation systems that depend on well-defined data structures and consistent metadata.

The construction industry exemplifies these challenges, where material selection decisions involve evaluating numerous options with complex interdependencies. Construction professionals must consider factors such as structural requirements, installation constraints, scheduling impacts, aesthetic considerations, and cost implications when selecting materials. The knowledge required to make these determinations often relies on specialized expertise and experience that may not be readily available or consistently applied across different projects and contexts.

Existing recommendation systems often struggle with datasets where structured information is inconsistent across entries, where specialized terminology and jargon are prevalent, and where the desired relationships between items are not explicitly defined. These limitations can result in incomplete or inaccurate recommendations that fail to capture the nuanced relationships between potentially interchangeable items.

### SUMMARY OF THE INVENTION

In one embodiment, a method for generating item recommendations from unstructured data includes obtaining a dataset comprising a plurality of items, wherein each item includes at least one field containing unstructured data, preprocessing the dataset by performing filtering and text cleanup on the unstructured data, performing a coarse relatedness analysis by executing lookups on items in the dataset to identify potentially similar items and create links between items that are potentially interchangeable, performing coarse clustering by utilizing the links to organize related items into clusters using graph operations, performing fine clustering by constructing prompts for a large language model for each cluster to recluster items into subclusters and generate labels for canonical items and generating a list of interchangeable item recommendations based on the canonical items and their associated metadata.

In more embodiments of the invention, the filtering comprises curation filtering to remove entries that are not well defined and keyword filtering to identify entries containing keywords indicating previously made interchangeability decisions.

In further embodiments of the invention, the keyword filtering identifies keywords comprising “replace,” “in lieu of,” and “ILO.”

In additional embodiments of the invention, the lookups are selected from the group consisting of: retrieval-augmented generation (RAG)-based lookup, term-based lookup, metadata-based lookup, and prompt-based similarity checks.

In still more embodiments of the invention, a RAG-based lookup embeds the item of interest and searches for similar embeddings.

In still further embodiments of the invention, a term-based lookup matches significant terms that appear within descriptions of items.

In additional embodiments again of the invention, the graph operations comprise segmentation on neighborhoods to find clusters.

In more embodiments of the invention also include incorporating one or more new items into an existing list of canonical items by comparing the new items against the canonical items using filtering and lookup techniques.

In further embodiments of the invention, the step of incorporating comprises constructing a large language model prompt to determine whether each new item is an exact match to a canonical item, generally related but a new relationship, or does not match an existing item.

In additional embodiments of the invention, the list of interchangeable item recommendations comprises fields selected from the group consisting of identifier, title, canonical item name, image, material, description, initial cost, performance and installation, appearance and aesthetics, durability and maintenance, sustainability and recycling, climate and environment, and cluster identifier.

In still more embodiments of the invention, a system for generating item recommendations from unstructured data includes a processor, and a memory storing instructions that, when executed by the processor, cause the system to obtain a dataset comprising a plurality of items, wherein each item includes at least one field containing unstructured data, preprocess the dataset by performing filtering and text cleanup on the unstructured data, perform a coarse relatedness analysis by executing lookups on items in the dataset to identify potentially similar items and create links between items that are potentially interchangeable, perform coarse clustering by utilizing the links to organize related items into clusters using graph operations, perform fine clustering by constructing prompts for a large language model for each cluster to recluster items into subclusters and generate labels for canonical items, and generate a list of interchangeable item recommendations based on the canonical items and their associated metadata.

In still further embodiments of the invention, the filtering comprises curation filtering to remove entries that are not well defined and keyword filtering to identify entries containing keywords indicating previously made interchangeability decisions.

In additional embodiments again of the invention, the keyword filtering identifies keywords comprising “replace,” “in licu of,” and “ILO.”

In more embodiments of the invention, the lookups are selected from the group consisting of: retrieval-augmented generation (RAG)-based lookup, term-based lookup, metadata-based lookup, and prompt-based similarity checks.

In further embodiments of the invention, a RAG-based lookup embeds the item of interest and searches for similar embeddings.

In additional embodiments of the invention, a term-based lookup matches significant terms that appear within descriptions of items.

In still more embodiments of the invention, the graph operations comprise segmentation on neighborhoods to find clusters.

In more embodiments of the invention, the instructions further cause the system to incorporate one or more new items into an existing list of canonical items by comparing the new items against the canonical items using filtering and lookup techniques.

In further embodiments of the invention, incorporating the one or more new items comprises constructing a large language model prompt to determine whether each new item is an exact match to a canonical item, generally related but a new relationship, or does not match an existing item.

In further embodiments of the invention, the list of interchangeable item recommendations comprises fields selected from the group consisting of identifier, title, canonical item name, image, material, description, initial cost, performance and installation, appearance and aesthetics, durability and maintenance, sustainability and recycling, climate and environment, and cluster identifier.

### BRIEF DESCRIPTION OF THE DRAWINGS

FIG. 1 illustrates a system for identifying interchangeable item recommendations in accordance with embodiments of the invention.

FIG. 2 illustrates a data processing server in accordance with embodiments of the invention.

FIG. 3 illustrates a process for identifying interchangeable item recommendations in accordance with embodiments of the invention.

FIG. 4 shows an example user interface screen for obtaining item information in accordance with embodiments of the invention.

FIG. 5 shows an example list of clusters in accordance with embodiments of the invention.

FIG. 6 shows an example list of cluster labels in accordance with embodiments of the invention.

FIGS. 7-9 show an example result listing of interchangeable item recommendations in accordance with embodiments of the invention.

### DETAILED DISCLOSURE OF THE INVENTION

Turning now to the drawings, systems and methods for generating recommendations (e.g. interchangeable item recommendations) using machine learning models are disclosed. The emergence of machine learning technologies, including large language models and advanced natural language processing techniques, has created new opportunities for extracting meaningful insights from unstructured data. These technologies offer the potential to identify patterns and relationships within complex datasets that traditional methods might overlook, enabling more sophisticated approaches to recommendation generation and item similarity analysis.

In many embodiments of the invention, the item recommendations are for material substitutions in the context of construction projects. However, the systems and methods described herein can be utilized to generate any of a variety of recommendations based upon a set of unstructured training data as appropriate to the requirements of specific applications. Certain embodiments of the invention can be extended to any of a variety of types of changes within a certain context or system that facilitates a process of designing or creating. For example, within the context of a project-based tracking system in some embodiments, an item may be defined as one of: changes in scope of the project, responsible party for a budget item, workflow tickets, etc. Some embodiments may process workflow tickets used to organize building software projects. Tickets can be consolidated into canonical items that are similar types of tasks, such as “fix padding bug in ux”, “paginate query”, or “integrate library for X.”

Many fields involve sets of items that act as resources with some degree of interchangeability. Decisions to select between items consider their similarity and differences based on properties of the items and suitability for the task at hand. For example, in the construction industry, selecting materials for each part of a project considers requirements of the project and individual structure to be built, constraints such as installation time and scheduling, and aesthetics. In particular, certain decisions involve first determining whether one material may be substituted for another. This can arise, for example, during renovations or when exploring alternative designs for a customer. It can be helpful to appreciate whether different materials may be used based on similar characteristics. This curation may not be straightforward and may require extensive knowledge of and prior experience using the materials. These types of decisions between a broader set of items can be aided by presenting the decision maker with a curated subset of the items that are interchangeable and may each be similarly suitable for the desired purposes. Embodiments of the invention can provide approaches to generate recommendations from unstructured data (e.g., user entries and/or existing datasets) so that it can be leveraged in a consistent and uniform manner for aiding in decision making. The systems and methods described herein can be utilized more broadly to train machine learning models using any of a variety of sources of unstructured data.

There are some characteristics of datasets containing unstructured data that can be particularly effective as training data for recommendation systems in accordance with embodiments of the invention. First, when the pieces of structured data available are not consistent across the whole dataset (e.g., each user tags their items in similar but different ways that are difficult to reconcile without some of the advantages of a recommendation system).

Second, when the unstructured fields are natural language descriptions, especially ones where specialized technical terms, abbreviations and/or jargon exist in a context that are not commonly used in other contexts (e.g. construction specific terms, such as CMU for Concrete Masonry Unit).

Third, when the type of structure that is desired to be pulled out of the data can be defined in advance (and known to exist within the dataset). For example, in some embodiments the structure is to identify material or system substitutions. Recommendation systems may not be effective without a directed target run on a broad dataset such as user chat messages and simply expecting it find insights.

### Systems for Finding Item Similarity and Recommendations

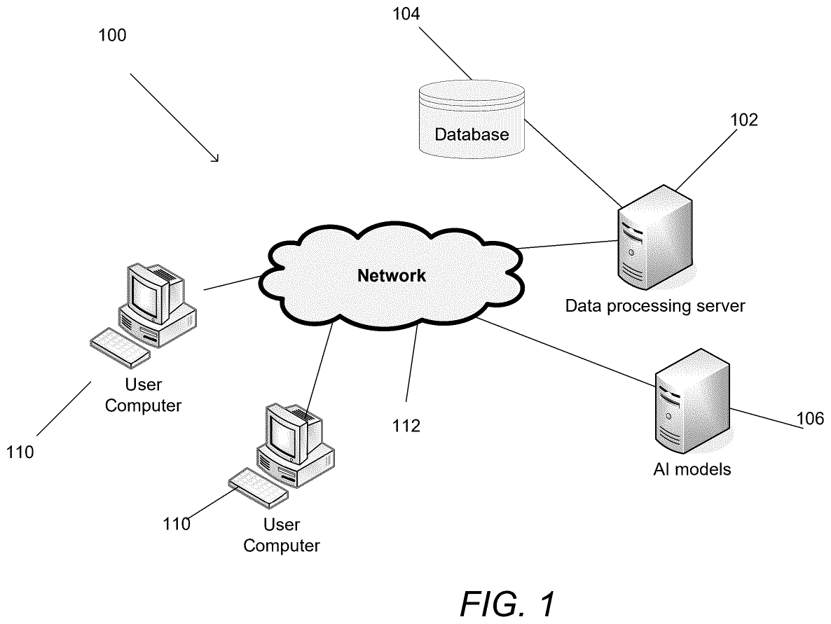

A system for finding item similarity given a dataset including unstructured data is illustrated in FIG. 1. The system 100 includes a data processing server 102, a database 104, a machine learning model computing device 106, and one or more user computers 110 communicating over a network 112 as illustrated in FIG. 1. While the database 104 is illustrated as a single entity here, it is understood that data sources and data stores be implemented in many forms, such as distributed systems or cloud services. Databases can include SQL databases such as Microsoft SQL server or Oracle SQL databases, MySQL, or noSQL databases. Data can be moved using any of a variety of available mechanisms, such as using such as Application Programming Interfaces (API).

A user computer 110 may receive user input that describes an item for storage in the database and to form part of a dataset for analysis. As will be discussed further below, the user input can include an item name, description, and other fields. In many embodiments, some or all of the data fields are provided as unstructured data. The data processing server 102 may read the dataset containing unstructured data from the database 104 and execute processes such as those described further below to organize the dataset and find similarities between items in it.

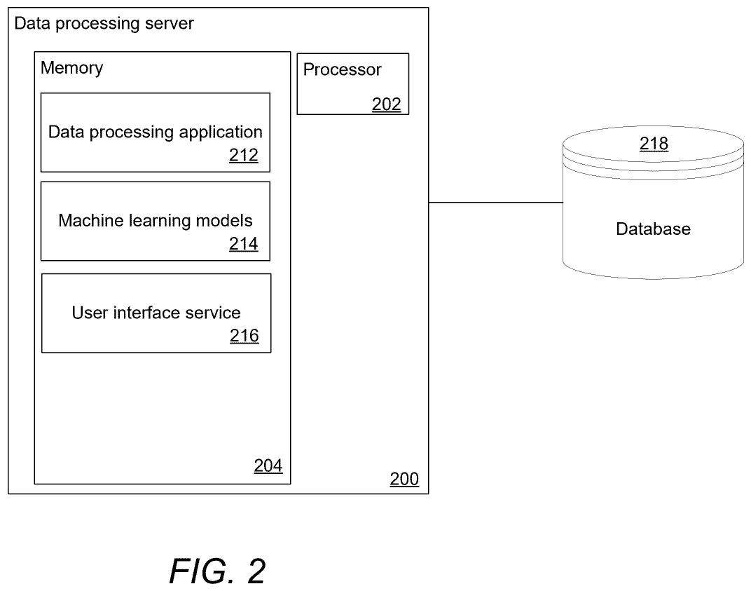

A data processing server in accordance with embodiments of the invention is conceptually illustrated in FIG. 2. The data processing server may be a computing system 200 that includes a processor 202 and memory 204 that includes a data processing application 212. The data processing application 212 can configure or direct the processor 202 to perform or execute processes such as those described further below on a dataset. The data processing application 212 may also utilize machine learning models 214 on the data processing server 200 or interact with models that are external to the data processing server 200. One skilled in the art will recognize that a data processing server may be implemented using other computing architectures, for example, as a virtual machine, as a cluster of computers, or using a cloud computing service.

Although specific system architectures are described above with reference to FIGS. 1 and 2, one skilled in the art will recognize that any of a variety of architectures may be utilized in accordance with embodiments of the invention.

### Processes for Finding Item Similarity and Recommendations

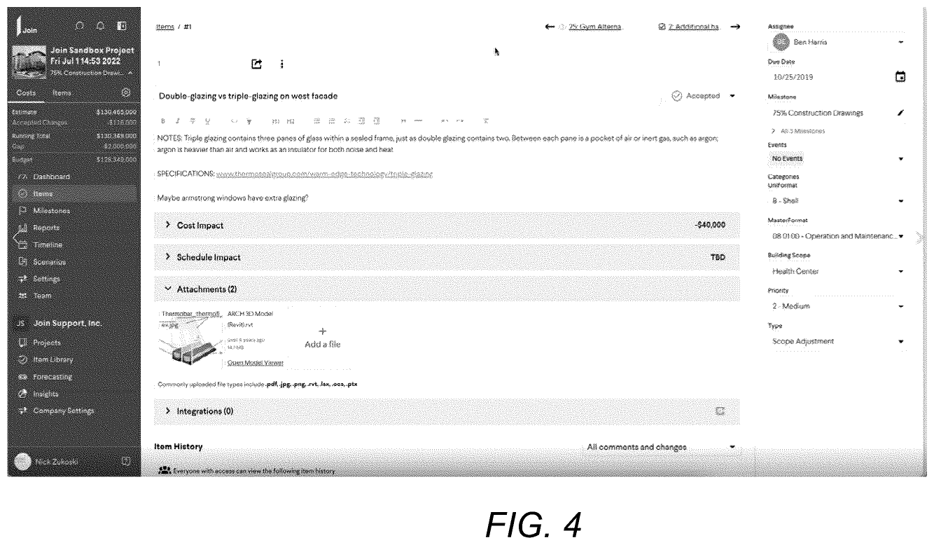

The process 300 includes obtaining (302) a dataset of items (e.g., materials names) and associated data. In several embodiments of the invention, entries of the dataset can be obtained by having one or more users enter information in a user interface screen containing fields (e.g., a web form) at least one of which accepts unstructured data. An example user interface screen in accordance with an embodiment of the invention is shown in FIG. 4. The screen can include fields such as, but not limited to, title, description, attachments, and/or metadata fields. Title can represent a name to refer to the item or material represented by the entry. Description can include a freeform text field for the capture of unstructured data. Attachments can capture one or more files or documents, which can be, for example, image or video showing visual elements. In some embodiments of the invention, the metadata fields can be user-defined fields containing semi-structured metadata. For example, when the data collected is related to construction projects, the metadata fields can include due date, milestone, events, building scope, priority, type (e.g., scope adjustment). Metadata fields can also include categories in UniFormat and/or MasterFormat.

The process includes a data preprocessing stage (304). The data preprocessing stage can include filtering and text cleanup.

Different types of filters can be applied to reduce the dataset or obtain initial information on relationships. Curation filtering can be utilized to remove entries in the dataset that are not well defined. For example, with a dataset of construction materials, entries that were created from test projects or projects that are “in-pursuit” (i.e., the general contractor has not yet won the contract) can be removed as potential sources of “noise”. Keyword filtering can identify where previous decisions had already been made on what items were interchangeable enough that they could be used in place of each other. This can be done by recognizing keywords that typically are used where like-for-like substitutions appear in user-entered descriptions or documents, e.g., ‘replace,’ ‘in lieu of,’, or ‘ILO’. Textual cleanup can be performed to correct typographical errors, formatting, or other abnormalities that could create issues in further processing.

In a coarse relatedness stage (306), any or all of a variety of lookups can be performed on items in the dataset to find potentially similar items and create individual links between various items that are speculated to be interchangeable, which can be explored in further processing. The result can be lists of items or links between items that are similar for further distinguishing analysis. For example, the process may find that paver material is linked to stamped concrete, and that paver material is linked to asphalt. The implication is that they are in the same area or are the same material. In many embodiments of the invention, lookups are performed for every item in the dataset. Lookups can include, but are not limited to, RAG-based lookup, term-based lookup, metadata-based lookup, and prompt-based similarity checks. As can readily be appreciated, any of a variety of different lookup techniques can be utilized as appropriate to the requirements of specific applications.

Retrieval-augmented generation (RAG) is a technique used in machine learning. RAG optimizes the output of a large language model (LLM) by referencing authoritative knowledge from outside of the LLM's training data sources before generating a response. RAG can extend the capabilities of LLMs to specific domains or an organization's internal knowledge base, without needing to retrain the model. In a RAG-based lookup, the item of interest is embedded and the process looks for similar embeddings.

Term-based lookup can match some of the most significant terms that appear in within descriptions of items. For example, if a term that is used is descriptive of a particular item or characteristic of an item, it displays a commonality with other items that use the term.

Metadata-based lookup can match one or more metadata fields across items. For example, a category field that has the same value across different items evidences a commonality between those items.

Prompt-based similarity checks can present lists of items (that were matched using other lookups or selected in other ways) to a large learning model (LLM). In many embodiments of the invention, the prompt can ask the LLM which items in the list seem similar or present some other criteria for finding similarity. Some embodiments of the invention utilize multi-shot prompting that utilize prompts that include examples of input and output that display the desired behavior.

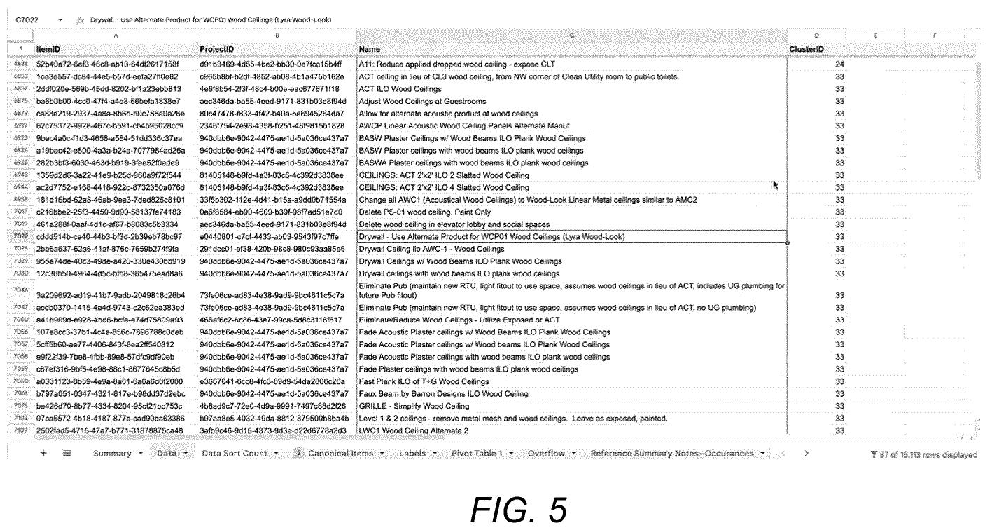

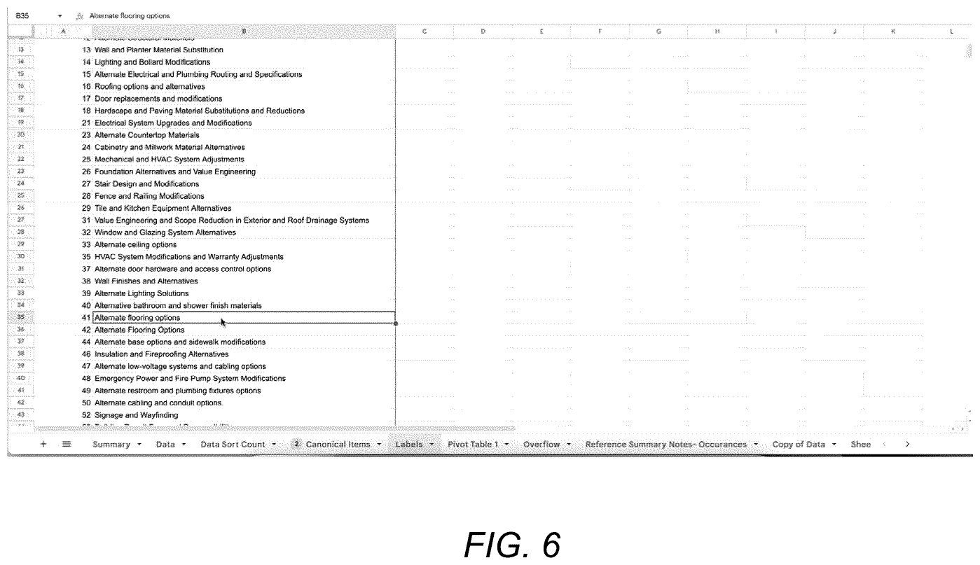

A coarse clustering and segmenting stage (308) utilizes the links that were found in the coarse relatedness stage to put all related items in a graph, where nodes are individual items/entries in the dataset. This typically may result in clusters that have some overlap where distinct ideas are still grouped together. Graph operations can be performed on the graph, e.g., segmentation on neighborhoods find clusters. For example, if there was a link from concrete pavers to asphalt, and a link from asphalt to stamped concrete, they may be merged to a single node. The output can be provided as a list of items and clusters to which they belong. FIG. 5 shows an example list of items and their assigned clusters. FIG. 6 shows an example list of labels of clusters. For example, a cluster can include all ceiling materials, while its subclusters include wood ceiling, acoustic ceiling tiles, and drywall ceiling (meaning individual materials and transitions between materials). Other clusters can include cabling and conduit, insulation and fireproofing, wall finishes, door hardware, stair design, countertop materials, lighting and bollard modifications. As seen in FIG. 6, some clusters at this stage may be so broad that there are two different labels such as 41 and 42 for alternative flooring.

A fine clustering and labeling stage (310) can be performed that is similar in approach as coarse relatedness and coarse clustering, but over each cluster rather than the entire dataset. In many embodiments of the invention, an LLM prompt is constructed for each coarse segment that was found. The prompt asks to recluster or summarize the set of items into subclusters by finding common patterns that are found throughout the set and provide summary label for each subcluster to distinguish it from the others. For example, a cluster that includes PVC and cast iron plumbing piping options can be broken down into subclusters that distinguish PVC piping from cast iron piping. The prompt can include a description of the task (e.g., to recluster based on similarities and rank the similarities) and example inputs and outputs. The results can provide labels to canonical items, i.e., those that are distinguished from all others. If the process has been performed before on the dataset (e.g., but with changes or new items), the results can be reconciled with the existing data. For example, the process may highlight clusters that do not exist in the current data, or may check if new items match an existing canonical item.

The results can be reviewed (312) and augmented with additional information for future use and reference. Results can take the form of a set of canonical items with associated metadata. In some embodiments of the invention, human review by subject matter experts can check the labels of canonical items and rankings provided to determine if they are valid real-life substitutions. In a construction context, this can include criteria such as that three distinct projects reference the same substitution. Some clusters that result may be so small that they can be eliminated.

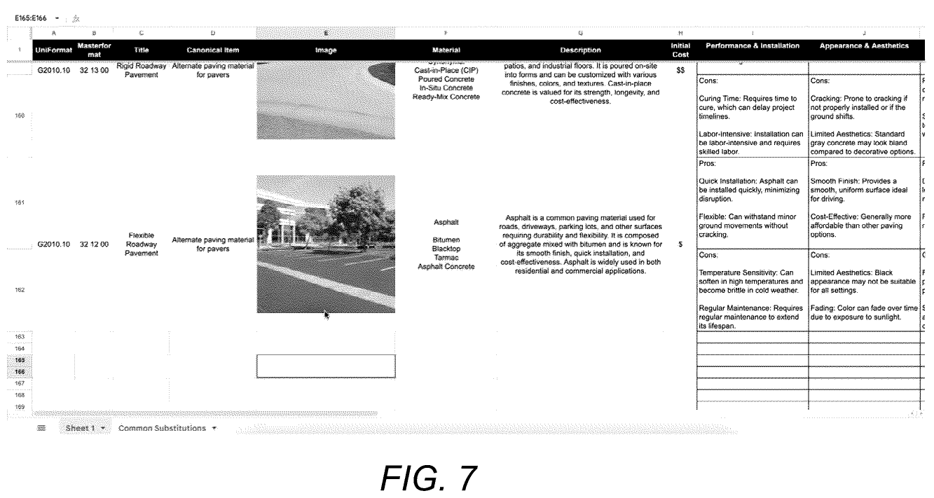

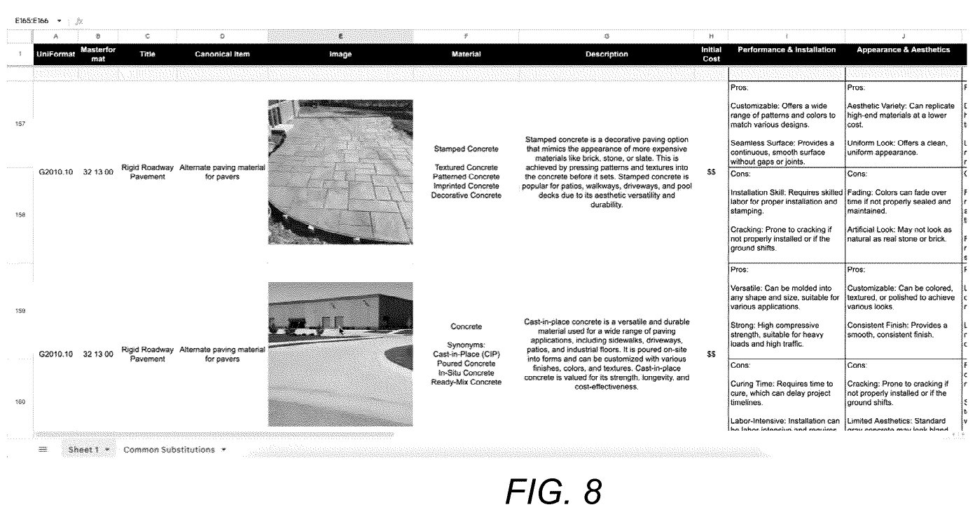

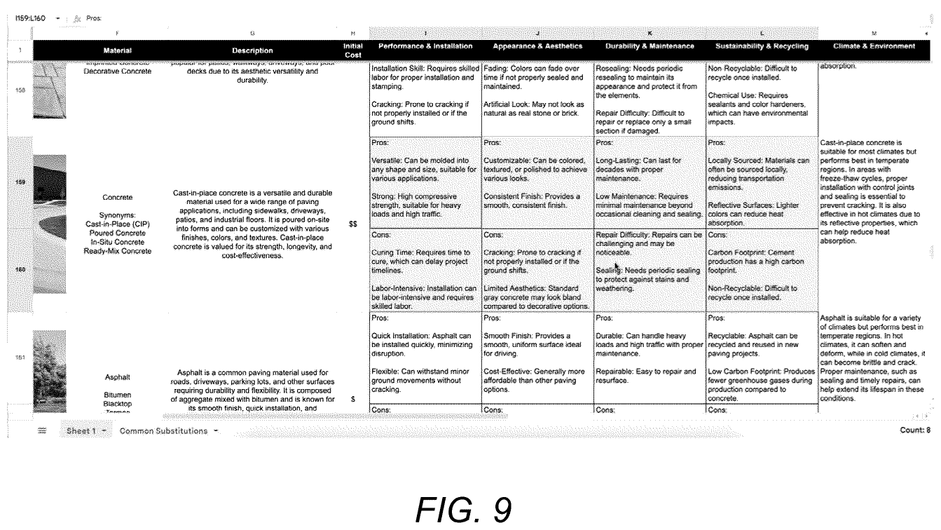

In several embodiments of the invention, an output list of the process can include fields such as, but not limited to, an Identifier, Title, Canonical Item name, Image, Material, Description, Initial Cost, Performance & Installation, Appearance & Aesthetics, Durability & Maintenance, Sustainability & Recycling, Climate and Environment, and Cluster ID/Item ID. An example output is shown in FIGS. 7, 8, and 9. Some fields may be generated by the process, such as identifier, title, canonical item name, material, initial cost, and Cluster ID/Item ID. Other fields such as Performance & Installation, Appearance & Aesthetics, Durability & Maintenance, Sustainability & Recycling, Climate and Environment can be written by a subject matter expert (e.g., materials researchers). Still other fields, such as description, may be generated, for example, by an LLM.

In additional embodiments of the invention, one or more new items (e.g., received as user input) can be incorporated (314) into an existing list of canonical items without regenerating the entire list. In several embodiments, the new item can also be added to the dataset for processing when a new list is generated by the process discussed above. The incorporation procedure can include utilizing one or more filtering (e.g., curation, keyword, textual, etc.) and/or lookup (e.g., RAG-based, term-based, metadata-based, and prompt-based similarity check) techniques for evaluating similarity, such as those discussed above, to compare the new item against the canonical items of the existing list.

The filtering and/or lookup can identify a subset of canonical items (e.g., 3-5 items) that are the potentially most relevant to compare further. An LLM prompt can be constructed to ask whether the new item is an instance of the canonical item(s) given some context, such as metadata associated with the canonical item or existing items from the dataset that are instances of the canonical item. A prompt can be created for each of the identified canonical items or all the identified canonical items can be included in the same prompt. In some embodiments, the LLM can output one of three answers: 1) the new item is an exact match to (an instance of) the canonical item, 2) the new item is generally related but is a new relationship/substitution, or 3) the new item does not match an existing item.

When the new item is an exact match, the record for that canonical item can be updated to reflect a stronger connection (e.g., with a higher rank). When the new item is generally related but is a new relationship/substitution, the new item may be incorporated given some additional filtering/criteria (e.g., if the substitution appears in three or more new items). When the new item does not match an existing item, it may have no effect on the canonical item list. In several embodiments, the new item can also be added to the dataset for processing when a new list is generated by the process discussed above.

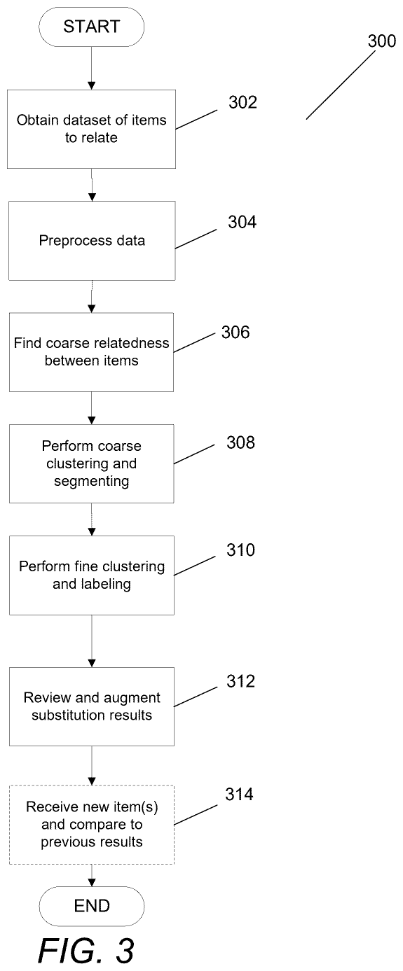

While a specific process for determining item similarity and substitution is described above with respect to FIG. 3, one skilled in the art will recognize that any of a variety of processes may be utilized in accordance with embodiments of the invention.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A computer-implemented method for generating item recommendations from unstructured data, comprising:
obtaining a dataset comprising a plurality of items, wherein each item includes at least one field containing unstructured data;
preprocessing the dataset by performing filtering and text cleanup on the unstructured data;
performing a coarse relatedness analysis by executing lookups on items in the dataset to identify potentially similar items and create links between items that are potentially interchangeable;
performing coarse clustering by utilizing the links to organize related items into clusters using graph operations;
performing fine clustering by constructing prompts for a large language model for each cluster to recluster items into subclusters and generate labels for canonical items; and
generating a list of interchangeable item recommendations based on the canonical items and their associated metadata.

2. The computer-implemented method of claim 1, wherein the filtering comprises curation filtering to remove entries that are not well defined and keyword filtering to identify entries containing keywords indicating previously made interchangeability decisions.

3. The computer-implemented method of claim 2, wherein the keyword filtering identifies keywords comprising “replace,” “in lieu of,” and “ILO.”

4. The computer-implemented method of claim 1, wherein the lookups are selected from the group consisting of: retrieval-augmented generation (RAG)-based lookup, term-based lookup, metadata-based lookup, and prompt-based similarity checks.

5. The computer-implemented method of claim 4, wherein a RAG-based lookup embeds the item of interest and searches for similar embeddings.

6. The computer-implemented method of claim 4, wherein a term-based lookup matches significant terms that appear within descriptions of items.

7. The computer-implemented method of claim 1, wherein the graph operations comprise segmentation on neighborhoods to find clusters.

8. The computer-implemented method of claim 1, further comprising incorporating one or more new items into an existing list of canonical items by comparing the new items against the canonical items using filtering and lookup techniques.

9. The computer-implemented method of claim 8, wherein the step of incorporating comprises constructing a large language model prompt to determine whether each new item is an exact match to a canonical item, generally related but a new relationship, or does not match an existing item.

10. The computer-implemented method of claim 1, wherein the list of interchangeable item recommendations comprises fields selected from the group consisting of identifier, title, canonical item name, image, material, description, initial cost, performance and installation, appearance and aesthetics, durability and maintenance, sustainability and recycling, climate and environment, and cluster identifier.

11. A system for generating item recommendations from unstructured data, comprising:
a processor; and
a memory storing instructions that, when executed by the processor, cause the system to:
obtain a dataset comprising a plurality of items, wherein each item includes at least one field containing unstructured data;
preprocess the dataset by performing filtering and text cleanup on the unstructured data;
perform a coarse relatedness analysis by executing lookups on items in the dataset to identify potentially similar items and create links between items that are potentially interchangeable;
perform coarse clustering by utilizing the links to organize related items into clusters using graph operations;
perform fine clustering by constructing prompts for a large language model for each cluster to recluster items into subclusters and generate labels for canonical items; and
generate a list of interchangeable item recommendations based on the canonical items and their associated metadata.

12. The system of claim 11, wherein the filtering comprises curation filtering to remove entries that are not well defined and keyword filtering to identify entries containing keywords indicating previously made interchangeability decisions.

13. The system of claim 12, wherein the keyword filtering identifies keywords comprising “replace,” “in lieu of,” and “ILO.”

14. The system of claim 11, wherein the lookups are selected from the group consisting of: retrieval-augmented generation (RAG)-based lookup, term-based lookup, metadata-based lookup, and prompt-based similarity checks.

15. The system of claim 14, wherein a RAG-based lookup embeds the item of interest and searches for similar embeddings.

16. The system of claim 14, wherein a term-based lookup matches significant terms that appear within descriptions of items.

17. The system of claim 11, wherein the graph operations comprise segmentation on neighborhoods to find clusters.

18. The system of claim 11, wherein the instructions further cause the system to incorporate one or more new items into an existing list of canonical items by comparing the new items against the canonical items using filtering and lookup techniques.

19. The system of claim 18, wherein incorporating the one or more new items comprises constructing a large language model prompt to determine whether each new item is an exact match to a canonical item, generally related but a new relationship, or does not match an existing item.

20. The system of claim 11, wherein the list of interchangeable item recommendations comprises fields selected from the group consisting of identifier, title, canonical item name, image, material, description, initial cost, performance and installation, appearance and aesthetics, durability and maintenance, sustainability and recycling, climate and environment, and cluster identifier.
